(19) United States
(12) Patent Application Publication
(10) Pub. No.: US 2020/0368812 A1
(43) Pub. Date: Nov. 26, 2020

(54) Systems and Methods for Fabricating Components

(71) Applicant: Desktop Metal, Inc., Burlington, MA (US)

(72) Inventors: Anna TRUMP, Burlington, MA (US); Matthew McCAMBRIDGE, Burlington, MA (US)

(73) Assignee: Desktop Metal, Inc., Burlington, MA (US)

(21) Appl. No.: 16/879,562

(22) Filed: May 20, 2020

Related U.S. Application Data
(60) Provisional application No. 62/850,683, filed on May 21, 2019.

(51) Int. Cl. B22F 3/00; B29C 64/165; B29C 64/393; B29C 64/218; B29C 64/209; B33Y 10/00; B33Y 30/00; B33Y 50/02

(52) U.S. Cl. CPC B22F 3/008; B29C 64/165; B29C 64/393; B33Y 50/02; B29C 64/209; B33Y 10/00; B33Y 30/00; B29C 64/218

(57) ABSTRACT

A method of printing an object using additive manufacturing includes depositing an amount of powder onto a print bed, spreading the amount of powder into a layer, depositing, in a first direction, a fluid configured to bind the powder onto at least a portion of the layer in a cross-sectional shape of the object to form the object, and depositing the fluid configured to bind the powder onto at least a portion of the layer adjacent to a leading edge of the cross-sectional shape of the object in the first direction to form at least one buffer element upstream of the cross-sectional shape of the object in the first direction.

### RELATED APPLICATION

This application claims the benefit of U.S. Provisional Application No. 62/850,683, filed on May 21, 2019. The entire teachings of the above application are incorporated herein by reference.

### TECHNICAL FIELD

Various aspects of the present invention relate generally to systems and methods for fabricating components.

### BACKGROUND

Powder bed three-dimensional fabrication is an additive manufacturing technique based on binding particles of a powder to form a three-dimensional object within the powder bed. Binder jetting is one type of powder bed three-dimensional fabrication. Binder jetting includes delivering powder, e.g., metal powder, to a print bed, spreading the powder into a layer, and depositing a binder material, e.g., a binder fluid, on top of the powder to bind the powder together. The binder material is deposited in a pre-determined pattern (e.g., in a cross-sectional shape of the three-dimensional object) to successive layers of powder in a powder bed such that the powder particles bind to one another where the binder material is located to form a three-dimensional green part. In the context of binder jet printing of three-dimensional metal objects, a three-dimensional green part may be formed by printing as described above, and may then be processed further into a finished three-dimensional metal part. For example, excess, unbound metal powder may be removed from the powder bed. Then, the three-dimensional green part may be heated in a furnace to remove the binder material and/or sintered to form the final, three-dimensional part.

However, when printing the green part, the delivery of the metal powder may cause inconsistencies in the density of the metal powder within the three-dimensional green part. For example, if the density of the metal powder within a layer changes across the layer, sintering the three-dimensional green part may cause the three-dimensional part to shrink unevenly, warp, and/or to otherwise change shape.

The systems and methods of the current invention may rectify some of the deficiencies described above, and/or address other aspects of the prior art.

### SUMMARY

Examples of the present invention relate to, among other things, systems and methods for fabricating components using additive manufacturing. Each of the examples disclosed herein may include one or more of the features described in connection with any of the other disclosed examples.

In one example, the present invention includes a method of printing an object using additive manufacturing. The method may include depositing an amount of powder onto a print bed, spreading the amount of powder into a layer, depositing, in a first direction, a fluid configured to bind the powder onto at least a portion of the layer in a cross-sectional shape of the object to form the object, and depositing the fluid configured to bind the powder onto at least a portion of the layer adjacent to a leading edge of the cross-sectional shape of the object in the first direction to form at least one buffer element upstream of the cross-sectional shape of the object in the first direction.

According to some aspects, the method may include one or more of the following features. The at least one buffer element may include a shape that conforms to a shape of the leading edge of the cross-sectional shape of the object. The method may further include depositing a second amount of powder onto the print bed, spreading the second amount of powder into a second layer, depositing, in a second direction, the fluid configured to bind the powder onto at least a portion of the second layer in a cross-sectional shape of the object to form the object, and depositing the fluid configured to bind the powder onto at least a portion of the second layer adjacent to a leading edge of the cross-sectional shape of the object in the second direction to form at least one buffer element upstream of the cross-sectional shape of the object in the second direction. The first direction may be different than the second direction so that the leading edge of the cross-sectional shape of the object in the first direction is different than the leading edge of the cross-sectional shape of the object in the second direction. The second direction may be opposite to the first direction.

The method may further include depositing a third amount of powder onto the print bed, spreading the third amount of powder into a third layer, depositing, in the first direction, the fluid configured to bind the powder onto at least a portion of the third layer in a cross-sectional shape of the object to form the object, and depositing the fluid configured to bind the powder onto at least a portion of the third layer adjacent to the leading edge of the cross-sectional shape of the object in the first direction to form the at least one buffer element upstream of the cross-sectional shape of the object in the first direction.

The method may further include depositing a third amount of powder onto the print bed, spreading the third amount of powder into a third layer, depositing, in a third direction, the fluid configured to bind the powder onto at least a portion of the third layer in a cross-sectional shape of the object to form the object, and depositing the fluid configured to bind the powder onto at least a portion of the third layer adjacent to a leading edge of the cross-sectional shape of the object in the third direction to form at least one buffer element upstream of the cross-sectional shape of the object in the third direction. The third direction may be different than the first direction and the second direction so that the leading edge of the cross-sectional shape of the object in the third direction is different than the leading edges of the cross-sectional shape of the object in the first direction and the second direction.

Depositing the fluid configured to bind the powder to form the at least one buffer element may include forming the at least one buffer element adjacent the leading edge and at least one other edge of the cross-sectional shape of the object. The at least one buffer element may be sacrificial to the object. Forming the at least one buffer element may reduce uneven powder distribution in the cross-sectional shape of the object, and the method may further include sintering the printed object without the at least one buffer element. Forming the at least one buffer element may include forming a plurality of buffer elements adjacent to and in contact with the leading edge. The method may further include separating the buffer elements from the object, once printed, and sintering the printed object. The at least one buffer element may be spaced away from the object by less than approximately 5 mm.

In another aspect, a method of printing an object using additive manufacturing may include depositing layers of powder, and depositing a binder material onto successive layers of the layers of powder to form the object. Depositing a first layer of the successive layers may include depositing, in a first direction, the binder material in a two-dimensional shape of the object in a plane to form the object, and depositing the binder material in the plane proximate to and separated from the two-dimensional shape of the object to form at least one buffer element adjacent a leading edge of the two-dimensional shape of the object in the first direction such that the at least one buffer element is formed upstream of the two-dimensional shape of the object in the first direction.

According to some aspects, the method may include one or more of the following features. A side of the at least one buffer element facing the two-dimensional shape of the object may include a shape that conforms to a shape of the leading edge of the two-dimensional shape of the object. Depositing a second layer of the successive layers may include depositing, in a second direction, the binder material in a two-dimensional shape of the object in a second plane to form the object, and depositing the binder material in the second plane proximate to and separated from the two-dimensional shape of the object to form at least one buffer element adjacent a leading edge of the two-dimensional shape of the object in the second direction such that the at least one buffer element is formed upstream of the two-dimensional shape of the object in the second direction. The first direction may be opposite to the second direction so that the leading edge of the cross-sectional shape of the object in the first direction is different than the leading edge of the cross-sectional shape of the object in the second direction. The at least one buffer element may be spaced away from the cross-sectional shape of the object by less than approximately 5 mm.

In yet another aspect, the present invention includes an apparatus for printing an object using additive manufacturing. The apparatus may include a build plate, a powder source configured to deposit a powder onto the build plate, a powder spreader configured to spread the powder across the build plate to form a layer of powder, a print head configured to deposit a binder material onto the layer of powder, and a controller configured to receive instructions to form the object out of the powder and the binder material on the build plate. The controller may be configured to instruct the powder source to deposit an amount of powder onto the build plate, instruct the powder spreader to spread the amount of powder into the layer, and instruct the print head to deposit, in a first direction, the binder material onto at least a portion of the layer in a cross-sectional shape of the object to form the object, and to deposit the binder material onto at least a portion of the layer adjacent to a leading edge of the cross-sectional shape of the object in the first direction to form at least one buffer element upstream of the cross-sectional shape of the object in the first direction.

According to some aspects, the apparatus may include one or more of the following features. The controller may be further configured to instruct the powder source to deposit a second amount of powder, instruct the powder spreader to spread the second amount of powder into a second layer, and instruct the print head to deposit, in a second direction, the binder material onto at least a portion of the second layer in a cross-sectional shape of the object to form the object, and to deposit the binder material onto at least a portion of the second layer adjacent to a leading edge of the cross-sectional shape of the object in the second direction to form at least one buffer element upstream of the cross-sectional shape of the object in the second direction. The controller may be configured to instruct the print head to deposit the binder material onto the layer surrounding the cross-sectional shape of the object to form at least one buffer element surrounding the cross-sectional shape of the object. The at least one buffer element may include a side having a shape that is conformal to a shape of the leading edge of the cross-sectional shape of the object and may be spaced away from the cross-sectional shape of the object by less than approximately 5 mm.

In a further aspect, the present invention includes a method of printing an object using additive manufacturing. The method may include depositing, in a first direction, an amount of powder onto a print bed, spreading the amount of powder into a layer, depositing, in a second direction, a fluid configured to bind the powder onto at least a portion of the layer in a cross-sectional shape of the object to form the object, and depositing the fluid configured to bind the powder onto at least a portion of the layer adjacent to a leading edge of the cross-sectional shape of the object in the second direction to form at least one buffer element upstream of the cross-sectional shape of the object in the second direction. The first direction may be different than the second direction.

Both the foregoing general description and the following detailed description are exemplary and explanatory only and are not restrictive of the features, as claimed. As used herein, the terms “comprises,” “comprising,” “including,” “having,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Additionally, the term “exemplary” is used herein in the sense of “example,” rather than “ideal.” It should be noted that all numeric values disclosed or claimed herein (including all disclosed values, limits, and ranges) may have a variation of +/−10% (unless a different variation is specified) from the disclosed numeric value. In this invention, unless stated otherwise, relative terms, such as, for example, “about,” “substantially,” and “approximately” are used to indicate a possible variation of +/−10% in the stated value. Moreover, in the claims, values, limits, and/or ranges of various claimed elements and/or features means the stated value, limit, and/or range+/−10%. The terms “object,” “part,” and “component,” as used herein, are intended to encompass any object fabricated through the additive manufacturing techniques described herein.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments. There are many aspects and embodiments described herein. Those of ordinary skill in the art will readily recognize that the features of a particular aspect or embodiment may be used in conjunction with the features of any or all of the other aspects or embodiments described in this invention.

FIG. 1A is a block diagram of an additive manufacturing system, FIG. 1B illustrates an exemplary fabrication subsystem, and FIG. 1C illustrates another exemplary fabrication subsystem, according to aspects of the present invention.

FIG. 2 is a flow chart of an exemplary method for additive manufacturing, according to aspects of the present invention.

FIG. 3 is a flow chart of another exemplary method for additive manufacturing, according to aspects of the present invention.

FIG. 4 is a top view of a printed part and a printed buffer element in an additive manufacturing assembly, according to aspects of the present invention.

FIG. 5 is a top view of printed parts with other printed buffer elements in an additive manufacturing assembly, according to aspects of the present invention.

FIG. 6 is a top view of a printed part with a further printed buffer element in an additive manufacturing assembly, according to aspects of the present invention.

FIG. 7 is a top view of a printed part with yet another printed buffer element in an additive manufacturing assembly, according to aspects of the present invention.

FIG. 8 is a top view of a printed part with an additional printed buffer element, according to aspects of the present invention.

FIG. 9 is a top view of a printed part having multiple leading edges with further printed buffer elements, according to aspects of the present invention.

### DETAILED DESCRIPTION

Embodiments of the present invention include systems and methods to facilitate and improve the efficacy and efficiency of additive manufacturing. Reference now will be made in detail to examples of the present invention described above and illustrated in the accompanying drawings. Wherever possible, the same reference numbers will be used throughout the drawings to refer to the same or like parts.

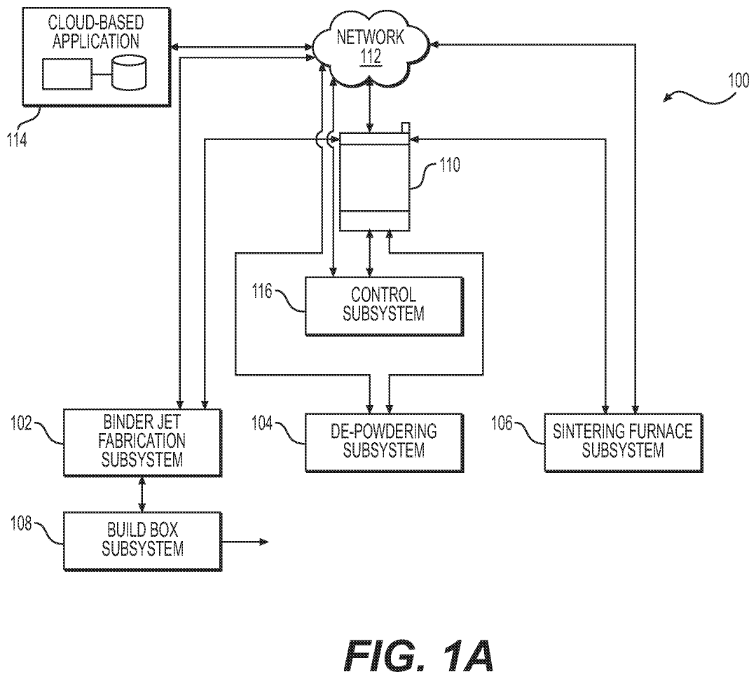

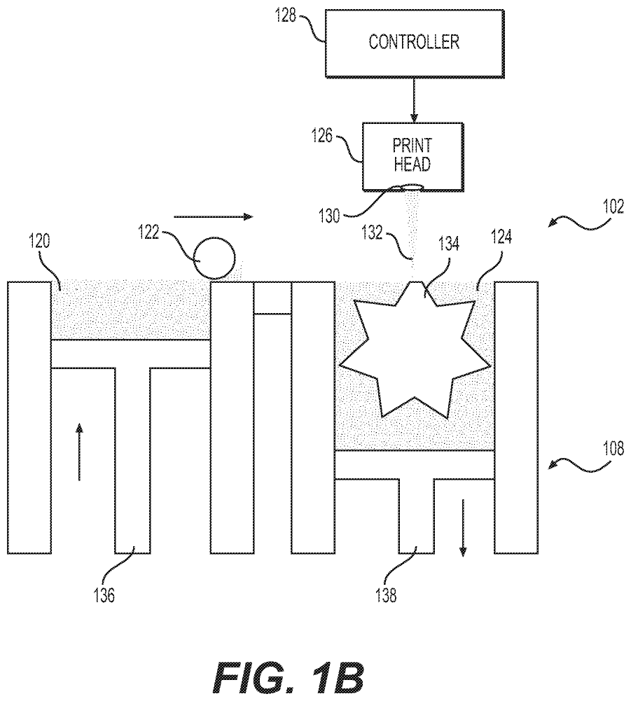

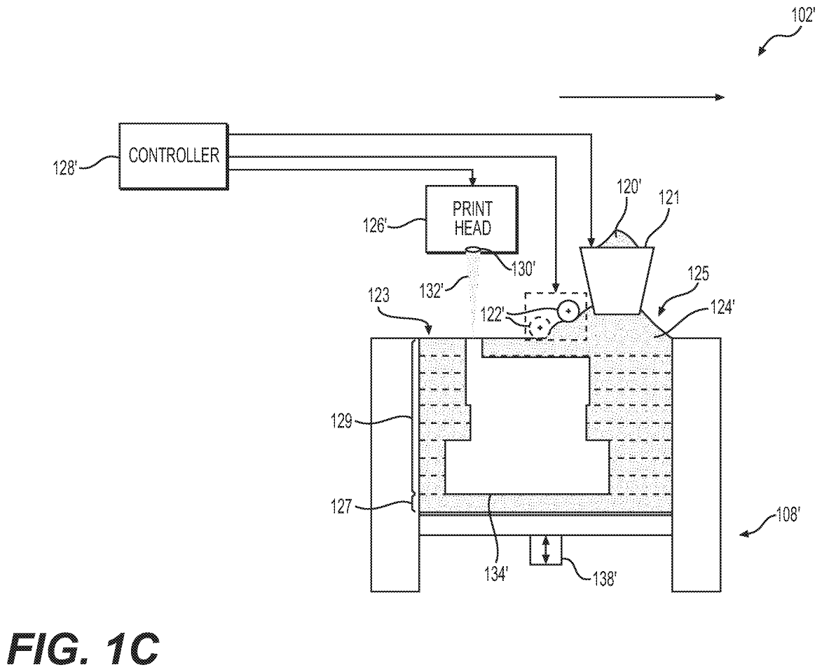

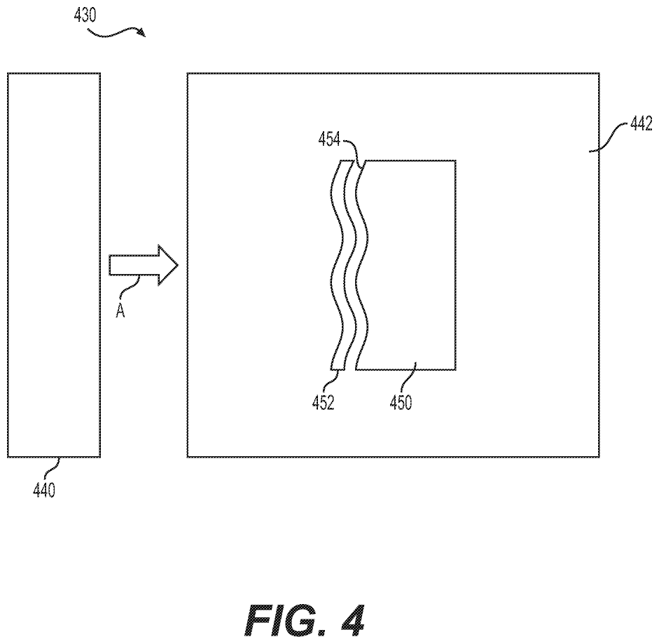

FIG. 1A illustrates an exemplary system 100 for forming a printed object, according to an embodiment of the present invention. System 100 may include a printer, for example, a binder jet fabrication subsystem 102, and a treatment site(s), for example, a de-powdering subsystem 104 and a sintering furnace subsystem 106. Binder jet fabrication subsystem 102 may be used to form an object from a build material, for example, by delivering successive layers of build material and binder material to a build plate 442 (FIG. 4). As shown in FIG. 1A, a build box subsystem 108 may be movable and may be selectively positioned in one or more of binder jet fabrication subsystem 102, de-powdering subsystem 104, and sintering furnace subsystem 106. For example, build box subsystem 108 may be coupled or couplable to a movable assembly. Alternatively, a conveyor (not shown) may help transport the object between portions of system 100.

The build material may be a bulk metallic powder delivered and spread in successive layers. The binder material may be, for example, a polymeric liquid that may be deposited onto and may be absorbed into layers of the build material. One or more of binder jet fabrication subsystem 102, de-powdering subsystem 104, and sintering furnace subsystem 106 may include a shaping station to shape the printed object and a debinding station to treat the printed object to remove a binder material from the build material. Furnace subsystem 106 may heat and/or sinter the build material of the printed object. System 100 may also include a user interface 110, which may be operatively coupled to one or more components, for example, to binder jet fabrication subsystem 102, de-powdering subsystem 104, and sintering furnace subsystem 106, etc. In some embodiments, user interface 110 may be a remote device (e.g., a computer, a tablet, a smartphone, a laptop, etc.). User interface 110 may be wired or wirelessly connected to one or more of binder jet fabrication subsystem 102, de-powdering subsystem 104, and sintering furnace subsystem 106. System 100 may also include a control subsystem 116, which may be included in user interface 110, or may be a separate element.

Binder jet fabrication subsystem 102, de-powdering subsystem 104, sintering furnace subsystem 106, user interface 110, and/or control subsystem 116 may each be connected to the other components of system 100 directly or via a network 112. Network 112 may include the Internet and may provide communication through one or more computers, servers, and/or handheld mobile devices, including the various components of system 100. For example, network 112 may provide a data transfer connection between the various components, permitting transfer of data including, e.g., geometries, the printing material, one or more support and/or support interface details, binder materials, heating and/or sintering times and temperatures, etc., for one or more parts or one or more parts to be printed.

Moreover, network 112 may be connected to a cloud-based application 114, which may also provide a data transfer connection between the various components and cloud-based application 114 in order to provide a data transfer connection, as discussed above. Cloud-based application 114 may be accessed by a user in a web browser, and may include various instructions, applications, algorithms, methods of operation, preferences, historical data, etc., for forming the part or object to be printed based on the various user-input details. Alternatively or additionally, the various instructions, applications, algorithms, methods of operation, preferences, historical data, etc., may be stored locally on a local server (not shown) or in a storage and/or processing device within or operably coupled to one or more of binder jet fabrication subsystem 102, de-powdering subsystem 104, sintering furnace subsystem 106, user interface 110, and/or control subsystem 116. In this aspect, binder jet fabrication subsystem 102, de-powdering subsystem 104, sintering furnace subsystem 106, user interface 110, and/or control subsystem 116 may be disconnected from the Internet and/or other networks, which may increase security protections for the components of system 100. In either aspect, an additional controller (not shown) may be associated with one or more of binder jet fabrication subsystem 102, de-powdering subsystem 104, and sintering furnace subsystem 106, etc., and may be configured to receive instructions to form the printed object and to instruct one or more components of system 100 to form the printed object.

FIG. 1B illustrates an exemplary binder jet fabrication subsystem 102 operating in conjunction with build box subsystem 108. Binder jet fabrication subsystem 102 may include a powder supply 120, a spreader 122 (e.g., a roller) configured to be movable across powder bed 124 of build box subsystem 108, a print head 126 movable across powder bed 124, and a controller 128 in electrical communication (e.g., wireless, wired, Bluetooth, etc.) with print head 126. Powder bed 124 may comprise powder particles, for example, micro-particles of a metal, micro-particles of two or more metals, or a composite of one or more metals and other materials.

Spreader 122 may be movable across powder bed 124 to spread a layer of powder, from powder supply 120, across powder bed 124. Print head 126 may comprise a discharge orifice 130 and, in certain implementations, may be actuated to dispense a binder material 132 (e.g., through delivery of an electric current to a piezoelectric element in mechanical communication with binder material 132) through discharge orifice 130 to the layer of powder spread across powder bed 124. In some embodiments, the binder material 132 may be one or more fluids configured to bind together powder particles.

In operation, controller 128 may actuate print head 126 to deliver binder material 132 from print head 126 to each layer of the powder in a pre-determined two-dimensional pattern, as print head 126 moves across powder bed 124. In embodiments, the movement of print head 126, and the actuation of print head 126 to deliver binder material 132, may be coordinated with movement of spreader 122 across print bed 124. For example, spreader 122 may spread a layer of the powder across print bed 124, and print head 126 may deliver the binder in a pre-determined, two-dimensional pattern, to the layer of the powder spread across print bed 124, to form a layer of one or more three-dimensional objects 134. These steps may be repeated (e.g., with the pre-determined two-dimensional pattern for each respective layer) in sequence to form subsequent layers until, ultimately, the one or more three-dimensional objects 134 are formed in powder bed 124.

Although the example embodiment depicted in FIG. 1B depicts a single object 134 being printed, it should be understood that the powder print bed 124 may include more than one object 134 in embodiments in which more than one object 134 is printed at once. Further, the powder print bed 124 may be delineated into two or more layers, stacked vertically, with one or more objects disposed within each layer.

An example binder jet fabrication subsystem 102 may comprise a powder supply actuator mechanism 136 that elevates powder supply 120 as spreader 122 layers the powder across print bed 124. Similarly, build box subsystem 108 may comprise a build box actuator mechanism 138 that lowers powder bed 124 incrementally as each layer of powder is distributed across powder bed 124.

In another example embodiment, layers of powder may be applied to powder print bed 124 by a hopper followed by a compaction roller. The hopper may move across powder print bed 124, depositing powder along the way. The compaction roller may be configured to follow the hopper, spreading the deposited powder to form a layer of powder.

For example, FIG. 1C illustrates another binder jet fabrication subsystem 102′ operating in conjunction with a build box subsystem 108′. In this aspect, binder jet fabrication subsystem 102′ may include a powder supply 120′ in a metering apparatus, for example, a hopper 121. Binder jet subsystem 102′ may also include one or more spreaders 122′ (e.g., one or more rollers) configured to be movable across powder bed 124′ of build box subsystem 108′, a print head 126′ movable across powder bed 124′, and a controller 128′ in electrical communication (e.g., wireless, wired, Bluetooth, etc.) with one or more of hopper 121, spreaders 122′, and print head 126′. Powder bed 124′ may comprise powder particles, for example, micro-particles of a metal, micro-particles of two or more metals, or a composite of one or more metals and other materials.

Hopper 121 may be any suitable metering apparatus configured to meter and/or deliver powder from powder supply 120′ onto a top surface 123 of powder bed 124′. Hopper 121 may be movable across powder bed 124′ to deliver powder from powder supply 120′ onto top surface 123. The delivered powder may form a pile 125 of powder on top surface 123.

The one or more spreaders 122′ may be movable across powder bed 124′ downstream of hopper 121 to spread powder, e.g., from pile 125, across powder bed 124. The one or more spreaders 122′ may also compact the powder on top surface 123. In either aspect, the one or more spreaders 122′ may form a layer 127 of powder. The aforementioned powder delivery and spreading steps may be successively performed in order to form a plurality of layers 129 of powder. Additionally, although two spreaders 122′ are shown in FIG. 1C, binder jet fabrication subsystem 102′ may include one, three, four, etc. spreaders 122′.

Print head 126′ may comprise a discharge orifice 130′ and, in certain implementations, may be actuated to dispense a binder material 132′ (e.g., through delivery of an electric current to a piezoelectric element in mechanical communication with binder material 132′) through discharge orifice 130′ to the layer of powder spread across powder bed 124′. In some embodiments, the binder material 132′ may be one or more fluids configured to bind together powder particles.

In operation, controller 128′ may actuate print head 126′ to deliver binder material 132′ from print head 126′ to each layer 127 of the powder in a pre-determined two-dimensional pattern, as print head 126′ moves across powder bed 124′. As shown in FIG. 1C, controller 128′ may be in communication with hopper 121 and/or the one or more spreaders 122′ as well, for example, to actuate the movement of hopper 121 and the one or more spreaders 122′ across powder bed 124′. Additionally, controller 128′ may control the metering and/or delivery of powder by hopper 121 from powder supply 120 to top surface 123 of powder bed 124′. In embodiments, the movement of print head 126′, and the actuation of print head 126′ to deliver binder material 132′, may be coordinated with movement of hopper 121 and the one or more spreaders 122′ across print bed 124′. For example, hopper 121 may deliver powder to print bed 124, and spreader 122′ may spread a layer of the powder across print bed 124. Then, print head 126 may deliver the binder in a pre-determined, two-dimensional pattern, to the layer of the powder spread across print bed 124′, to form a layer of one or more three-dimensional objects 134′. These steps may be repeated (e.g., with the pre-determined two-dimensional pattern for each respective layer) in sequence to form subsequent layers until, ultimately, the one or more three-dimensional objects 134′ are formed in powder bed 124′.

Although the example embodiment depicted in FIG. 1C depicts a single object 134′ being printed, it should be understood that the powder print bed 124′ may include more than one object 134′ in embodiments in which more than one object 134′ is printed at once. Further, the powder print bed 124′ may be delineated into two or more layers 127, stacked vertically, with one or more objects disposed within each layer.

As in FIG. 1B, build box subsystem 108′ may comprise a build box actuator mechanism 138′ that lowers powder bed 124′ incrementally as each layer 127 of powder is distributed across powder bed 124′. Accordingly, hopper 121, the one or more spreaders 122′, and print head 126′ may traverse build box subsystem 108′ at a pre-determined height, and build box actuator mechanism 138′ may lower powder bed 124 to form object 134′.

Although not shown, binder jet fabrication subsystems 102, 102′ may include a coupling interface that may facilitate the coupling and/or uncoupling of the build box subsystems 108, 108′ with the binder jet fabrication subsystems 102, 102′, respectively. The coupling interface may comprise one or more of (i) a mechanical aspect that provides for physical engagement, and/or (ii) an electrical aspect that supports electrical communication between the build box subsystem 108, 108′ to the binder jet fabrication subsystem 102, 102′.

In binder jetting or powder material deposition, when printing the green part, the delivery of the layers of powder and/or binder may yield an uneven distribution or inconsistencies in the density of the metal powder within the three-dimensional green part. Additionally or alternatively, interaction of the powder and the binder in respective layers or between adjacent layers may yield an uneven distribution or inconsistencies in the density of the metal powder within the three-dimensional green part. For example, if the density of the powder within a layer changes across the layer, sintering the three-dimensional green part may cause the three-dimensional part to shrink unevenly, warp, and/or to otherwise change shape during the sintering. This may be because the region of the printed part that has a lower powder density will have a larger amount of open porosity to be closed during sintering. Therefore, when the part is sintered to achieve a more consistent final density throughout the entirety of the part, the region with the lower initial powder density may shrink more that its denser counterpart regions, causing the part to warp. The changes in shape may negatively affect the integrity, strength, shape, or other aspects of the printed part. One or more aspects of this invention may address the above issues.

For example, in exemplary embodiments, system 100 may form one or more buffer structures, buffer elements, or secondary structures (collectively “buffer elements”) to the printing instructions for the object. Inconsistencies in the density of powder within a layer may be more common on the leading edge of an object (e.g., the leading edge in a printing direction may be more dense than the remainder of the powder), so one or more buffer elements may be formed upstream of the object in the direction of printing within the build box subsystem. By forming the buffer elements upstream of the part, powder inconsistencies (e.g., higher powder densities) may predominantly be contained within the buffer elements, and the powder downstream of the buffer elements with a more consistent density may be used to form the object. The buffer elements may be formed by depositing binder material 132 on powder bed 124 to bind deposited powder upstream of the object, as will be discussed further below.

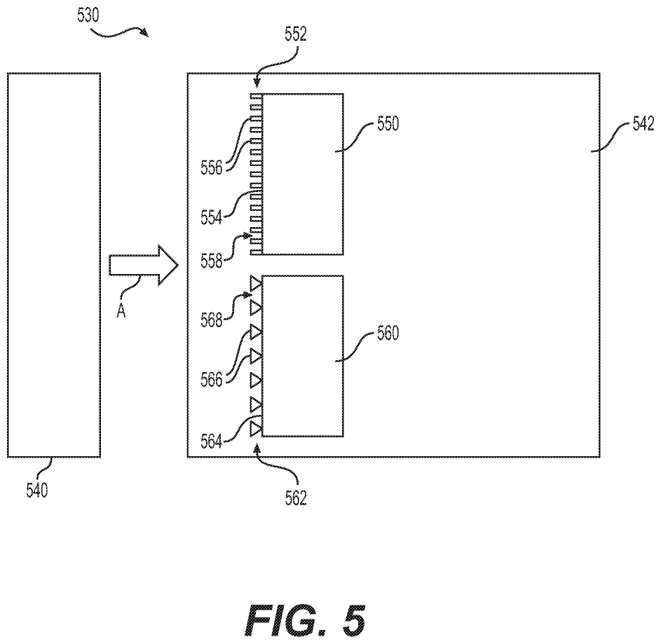

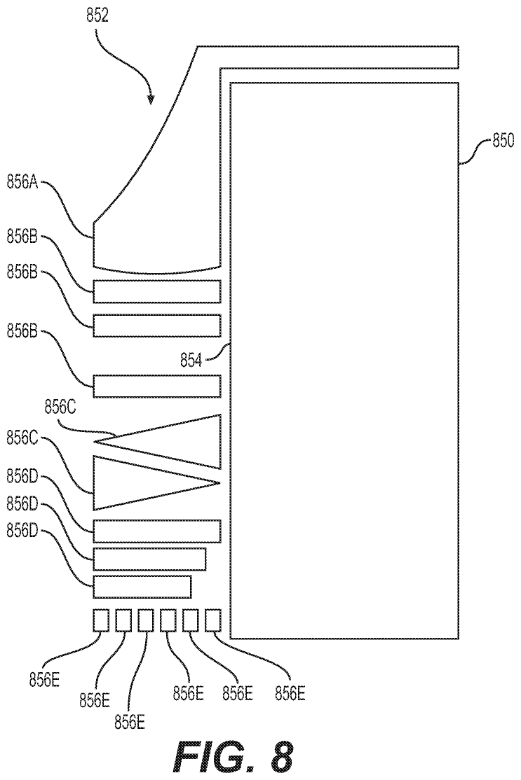

In one aspect, system 100 or other components may indicate to a user how many buffer structures or buffer elements should be positioned adjacent to the printed object and where the buffer elements should be positioned relative to the printed object during the printing of the object. For example, in one aspect, one or more portions of the buffer structures or buffer elements may be proximate to the printed object, with a small space or gap between the one or more portions of the buffer structures or buffer elements and the printed object (FIGS. 4 and 8). In another aspect, one or more portions of the buffer structures or buffer elements may be in contact with the printed object (FIGS. 5-7). The term “adjacent,” as used herein, may collectively refer to buffer elements that are touching the printed object or are separated from the printed object by a small space or gap. The number and placement of the buffer structures or buffer elements may be based on software, product documentation, or other factors, as described herein. Next, system 100 may allow for the user to select the number or placement of the buffer elements. Guidance on the position, size, and/or other factors may be provided by software, product documentation, etc. System 100 or another component may estimate a printing time for the printed object. The object, various settings (either pre-programmed or user-defined), and the buffer element number, position, and other information may be provided to a slicer algorithm/program, and the slicer may prepare instructions for printing the object. Then, one or more components (e.g., binder jet fabrication subsystem 102) may receive the instructions and print the object according to the instructions. One or more components of system 100 (e.g., de-powdering subsystem 104, sintering furnace subsystem 106) may be used to shape, treat, de-powder, and/or heat/sinter the object.

In another aspect, system 100 or other components may indicate to a user how many buffer structures should be included adjacent to the printed object, and where the buffer elements should be positioned relative to the printed object. The number and placement of the buffer elements may be based on software, product documentation, or other factors, as described herein. Next, system 100 may allow for the user to place the buffer elements, and guidance on the position, size, and/or other factors may be provided by software, product documentation, etc. The printing of the object may be simulated, and simulation results may be provided to the user or to software. The user may make modifications (if necessary) to the printing instructions, for example, to the placement, number, size, etc. of the buffer elements, in order to print the object more efficiently, effectively, quickly, etc. The printing of the modified object may be simulated again, if necessary.

The modifications to the printing instructions for the object to be printed and simulation of printing of the object may be repeated as many times as desired until a desirable simulation outcome is achieved. The object, various settings (either pre-programmed or user-defined), and the buffer element number, position, and other information may be provided to a slicer algorithm/software, and the slicer may prepare instructions for printing the object. Then, one or more components (e.g., binder jet fabrication subsystem 102) may receive the instructions and print the object and buffer structures according to the instructions. One or more components may be used to treat the printed object, for example, a furnace may be used to sinter the object.

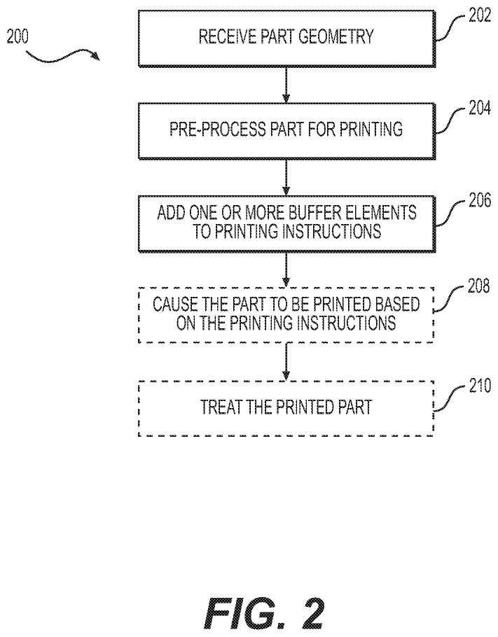

FIG. 2 is a flow chart of an exemplary method that may be performed by various elements of system 100 to form a printed part through additive manufacturing. Method 200 may be used to form the object that includes at least one buffer element 452 (e.g., FIG. 4) using binder jet fabrication subsystem 102. For example, one or more processors, memories (with various instructions, applications, algorithms, methods of operation, preferences, etc., stored thereon), transmitters, receivers, may be included in a single system component (e.g., binder jet fabrication subsystem 102), or may be distributed among multiple components of a system.

In one aspect, a step 202 includes receiving a part geometry. In step 202, a user may input a desired part geometry. For example, a user may upload an electronic file with the part geometry for the object to be printed, via, e.g., user interface 110 or cloud-based application 114. In some embodiments, the user may select a pre-loaded or stored part geometry or may select a part geometry that was printed previously. The part geometry may include a three-dimensional design of the object to be printed. The part geometry may also include details, part specifications, and/or information concerning the exterior and interior requirements for the object to be printed, for example, a minimum force that the object or portions of the object must be able to withstand.

Next, a step 204 includes pre-processing the part geometry for printing. Step 204 converts the part geometry provided by a user to printing instructions to be performed by a printer, for example, binder jet fabrication subsystem 102. The part geometry received in step 202 may also be slightly larger than the desired final part in order to account for shrinkage during a treatment process (e.g., sintering). Alternatively, step 204 may include adjusting the part geometry in order to account for shrinkage during a treatment process (e.g., sintering). The pre-processing step 204 may include dividing the part geometry into a plurality of layers or slices, with each slice corresponding to a layer of powder and/or binder material to be spread or deposited. Step 204 may also include adjusting and/or supplementing the printing instructions to include instructions for the printer to form one or more support structures, one or more interface layers (e.g., formed of a ceramic that does not appreciably sinter at the build material sintering temperatures) between the printed object and the one or more support structures, one or more base or raft structures (e.g., a structure beneath the supports and printed part), which may help maintain a uniform size and shape of the printed object during the formation process, etc. Pre-processing step 204 may convert the part geometry and any supplemental structures or layers into a G-code or another programming language to generate instructions to be executed by the printer to print the object and any supplemental structures.

A step 206 includes adding one or more buffer elements to the printing instructions for the object. Step 206 may include simulating the object as it will be printed by the printer, and software, either on user interface 110, on cloud-based application 114, or elsewhere in system 100, may position the one or more buffer elements based on the simulated object.

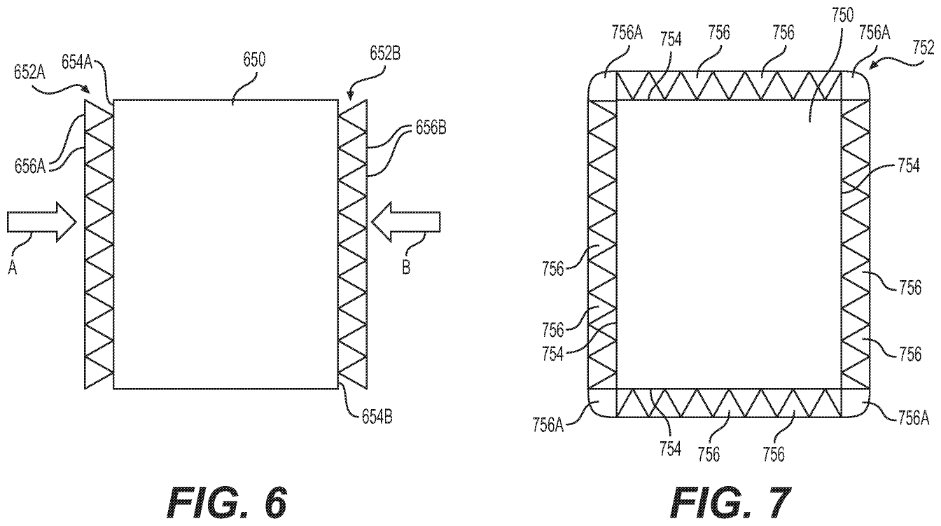

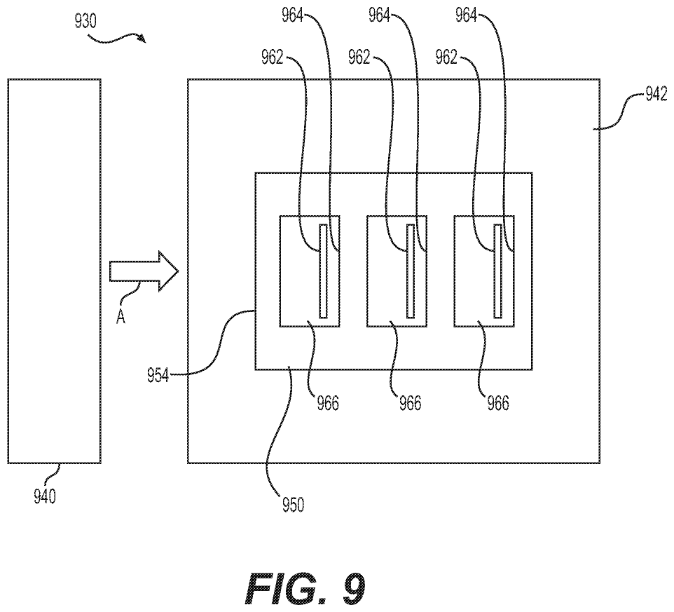

In one aspect, step 206 may include positioning a buffer element 452 on a first side of the object 450 (FIG. 4). For example, buffer element 452 may be positioned to extend parallel to and spaced away from one side (e.g., a leading edge 454) of the object 450. In another aspect, step 206 may include positioning one or more buffer elements 556, 566 extending from one side of the object 550, 560 (FIG. 5). For example, a plurality of buffer elements may be adjacent to and/or extend away from one side (e.g., leading edge 554, 564) of the object 550, 560. In one aspect, the plurality of buffer elements (e.g., buffer elements 566 in FIG. 5) may have a shape such that the portion of the buffer element that is in contact with the object may have a narrower width (in a plane of the layer or slice of the part) than a portion of the buffer element that is not in contact with the object. In another aspect, step 206 may include positioning one or more buffer elements around and/or extending from two sides of the object (FIG. 6), or positioning one or more buffer elements around and/or extending from all sides of the object (FIG. 7). In yet another aspect, step 206 may include positioning one or more buffer elements of different shapes and/or sizes around and/or extending from one or more sides of the object (FIG. 8). Moreover, in another aspect, step 206 may include positioning one or more buffer elements around or extending from one or more internal faces or sides of the object, for example, when the object includes one or more internal openings (FIG. 9).

Various factors may be weighed by the processing and software, which may be performed on user interface 110, on a binder jet fabrication subsystem 102, as a cloud-based application 114, or by a remote processor connected to the system (e.g., a computer, smartphone, tablet, etc.). The recommended sizes, positions, and/or shapes of the one or more buffer elements may take into account the geometry and size of the object to be printed. For example, the one or more buffer elements may be positioned adjacent to straight portions of the object, adjacent to curved portions of the object, along entire leading edge(s) of the object, or around an entirety of the object. The one or more buffer elements may be positioned spaced away from the object, for example, by approximately 5 mm or less, by approximately 0.3 mm, by approximately 100 microns, or by approximately 3-5 times a mean particle size of the build material and/or the binder material used to print the object. For example, if the metal powder includes a d90 of −25 (i.e., 90% of the particles are less than 25 microns), the one or more buffer elements may be spaced away from the object by approximately 75 to 125 microns. Additionally or alternatively, the one or more buffer elements may be positioned spaced away from the object, for example, by a distance at which the buffer element does not fuse to the part during printing and also reduces or removes the density inhomogeneity in the part that leads to warping during sintering.

The one or more buffer elements may be positioned to allow for an efficient delivery of the build material and/or the binder material, while also balancing the usage of the build material and/or the binder material. For example, the one or more buffer elements may be positioned in or more positions relative to the printed object in order to promote an even and homogeneous delivery of build material for the printed object, while also reducing the amount of binder material and/or build material being necessary to form the buffer elements and the printed object in order to reduce printing cost and/or printing time. Additionally, the number, position, shape, etc. of the one or more buffer elements may help system 100 and/or a user to collect excess build material to be disposed of, recycled, reused, etc., as will be explained further below.

The one or more buffer elements may be positioned adjacent to (either in contact with or spaced away from) one or more leading edges of the printed object. For example, if binder jet fabrication subsystem 102 prints in a single direction, the one or more buffer elements may be positioned adjacent to or upstream of the edge of the printed object that is printed first (FIGS. 4 and 5). As shown in FIGS. 4 and 5, printed heads 440, 540 are configured to move in printing direction A to print objects 450, 550, 560, and thus one or more buffer elements 452, 556, 566 may be printed upstream of leading edges 454, 554, 564. In another aspect, if binder jet fabrication subsystem 102 prints in two directions, the one or more buffer elements may be positioned adjacent to the edge of the printed object that is printed first when binder jet fabrication subsystem 102 prints in a first direction, and also positioned adjacent to the edge of the printed object that is printed first when binder jet fabrication subsystem 102 prints in a second direction (FIGS. 6 and 7).

If the leading edge of the printed object includes an irregular (not straight) shape, the one or more buffer elements may conform to or mimic the shape of the leading edge. For example, the one or more buffer elements may extend from the leading edge a constant distance, or may be spaced away from the leading edge by a constant distance (FIG. 4). In another aspect, the one or more buffer elements may be spaced away from the leading edge by a non-constant distance. For example, the one or more buffer elements may be spaced from a closest portion of the leading edge by a certain distance, and the other portions of the buffer element or the other of the one or more buffer elements may be spread in a straight line perpendicular to a printing direction.

The one or more buffer elements may be positioned adjacent to one or more critical portions of the object, for example, a portion that will undergo relatively more stress during use compared to the rest of the object. The one or more buffer elements positioned adjacent to the one or more critical portions of the object may help ensure that the critical portions include an even powder distribution. The number and size of buffer elements may be balanced with the amount of build material and binder material required to form the buffer elements. In one aspect, a larger number or size of buffer elements may allow for a more even distribution of build material for the printed object, but may also increase the printing time and/or the amount of build material and binder material required to form both the object and the buffer elements. Step 206 may include weighing the build material distribution with the usage of build material and binder material, including the overall object mass, overall volume of the object, overall size of the object, the thickest cross-section of the object, the build material and binder material being used to print the object, etc. In some embodiments, a user may prioritize (i.e., assign more weight to) one factor or another, or may set limits (e.g., not to use more than a certain amount of build material). Additionally, a user or method 200 may incorporate any known data, e.g., historical data, or experimental results when positioning and sizing the one or more buffer elements relative to specific geometries of the printed object.

Steps 204 and 206 may result in a set of instructions for printing the object. These instructions may be stored for later use or may be transmitted to and/or received by a printer (e.g., binder jet fabrication subsystem 102).

Next, an optional step 208 includes causing the object to be printed based on the printing instructions. Step 208 may immediately cause the object to be printed once step 206 is completed or may cause the object to be printed at a later time. Step 208 includes the printer, for example, binder jet fabrication subsystem 102 and a print head 440, executing the instructions to form the object. For example, the printer may execute the instructions to form the object in layer-by-layer slices. Step 208 may include forming a shell and an infill with a determined structure and arrangement. Step 208 may include depositing and spreading layers or sheets of a build material on a build plate, with layers of binder material being deposited where the object is to be formed in order to bind the layers of build material. Step 208 may also include depositing layers of binder material where the one or more buffer elements are to be formed.

Once the object is printed, an optional step 210 includes treating the printed object, for example, within de-powdering subsystem 104 or sintering furnace subsystem 106. For example, step 210 may include submerging the printed object in a debinding fluid or solution. Step 210 may include sintering the printed object. Step 210 may include heating the object, for example, in sintering furnace subsystem 106. The heating may include incremental temperature increases, with different temperatures being maintained within the furnace for various portions of the sintering process. Alternatively or additionally, when the one or more buffer elements contact the printed object (e.g., buffer elements 556, 566), the one or more buffer elements may be separated (e.g., broken off) from the printed object either before step 210, during step 210, or after step 210. In this aspect, the one or more buffer elements may optionally be separated from the printed object before sintering the printed object, or after sintering the printed object.

In one aspect, a portion of step 210 may include heating a furnace to a first temperature such that a portion of the object, for example, the binder material, may burn off or otherwise be removed. This portion of step 210 may include a thermal debinding. In this aspect, the portion of step 210 may heat the object to remove a polymer or another portion of the object, for example, the binder material. The binder material may burn off when subjected to heat within the furnace. The binder material may be collected and disposed of, recycled, reused, etc.

Another portion of step 210 may include heating the furnace to a second temperature, higher than the first temperature, to sinter the printed object. This portion of step 210 may diffuse atoms of the object material across particle boundaries to fuse the object into a solid piece. In this aspect, the one or more buffer elements 452, 552, 562, 652A, 652B, 752, 852 may have helped to ensure an even and consistent delivery of the build material in the layers of the printed object during step 208. As a result, the printed object may sinter uniformly (e.g., shrink evenly to avoid warping or unintended shape changes).

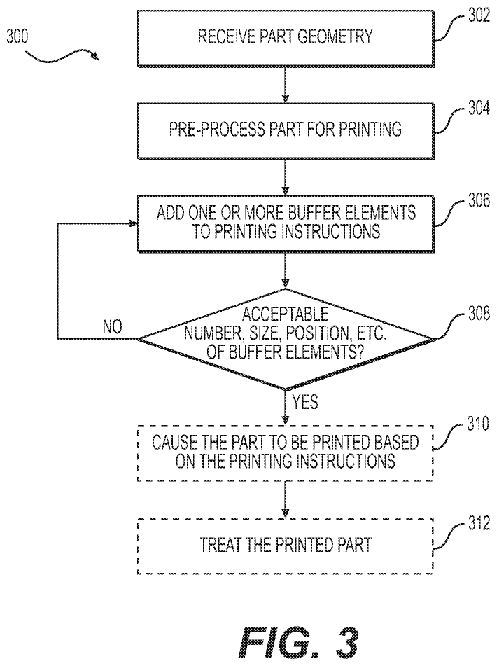

FIG. 3 depicts a flowchart of an exemplary method 300 of forming a printed component through additive manufacturing, according to another embodiment of this invention. Like method 200, method 300 may be performed by binder jet fabrication subsystem 102, system 100, or any subset of the components discussed herein. For example, one or more processors, memories (with various instructions, applications, algorithms, methods of operation, preferences, historical data, etc., stored thereon), transmitters, receivers, may be included in a single system component (e.g., binder jet fabrication subsystem 102), or may be distributed among multiple components of a system. It is noted that method 300 is additionally similar to method 200, except that a user may define the number, location, size, and other characteristics of the buffer element(s).

In one aspect, in step 302, system 100 may receive a part geometry. In step 302, a user may input a desired part geometry. For example, a user may upload or otherwise input a design for a printed component (e.g., object 450) to system 100. For example, a user may upload an electronic file with the part geometry for the object to be printed, via, e.g., user interface 110 or cloud-based application 114. In some embodiments, the user may select a pre-loaded or stored part geometry or may select a part geometry that was printed previously. The part geometry may include a three-dimensional design of the object to be printed. The part geometry may also include details, part specifications, and/or information concerning the exterior and interior requirements for the object to be printed, for example, a minimum force that the object or portions of the object must be able to withstand.

As in step 204, a step 304 may include pre-processing the object for printing by converting the part geometry provided by a user to printing instructions to be performed by a printer, for example, binder jet fabrication subsystem 102. The pre-processing step 304 may include dividing the part geometry into a plurality of layers or slices, with each slice corresponding to a layer of build material and binder material to be spread or deposited. Step 304 may also include adjusting and/or supplementing the printing instructions to include instructions for the printer to form one or more support structures, one or more interface layers (e.g., formed of a ceramic that does not appreciably sinter at the build material sintering temperatures) between the printed object and the one or more support structures, one or more base or raft structures (e.g. a structure beneath the supports and printed part), which may help maintain a uniform size and shape of the printed object during the formation process, etc. Pre-processing step 304 may convert the part geometry and any supplemental structures or layers into a G-code or another programming language to generate instructions to be executed by the printer to print the object and any supplemental structures.

Next, a step 306 includes adding one or more buffer elements to the printing instructions for the object. Step 306 may include simulating the object as it will be printed by the printer, and software, either on user interface 110, on cloud-based application 114, or elsewhere in system 100, and may include positioning the one or more buffer elements based on the simulated printing of the object. In one aspect, step 306 may include positioning a buffer element 452 on a first side of the object 450 (FIG. 4). For example, buffer element 452 may be positioned to extend parallel to and spaced away from one side (e.g., a leading edge 454) of the object 450. In another aspect, step 306 may include positioning one or more buffer elements 556, 566 extending from one side of the object 550, 560 (FIG. 5). For example, a plurality of buffer elements may be adjacent to and/or extend away from one side (e.g., leading edge 554, 564) of the object 550, 560. In one aspect, the plurality of buffer elements (e.g., buffer elements 566 in FIG. 5) may have a shape such that the portion of the buffer element that is in contact with the object may have a narrower width (in the plane of the slice of the part) than a portion of the buffer element that extends away from the object. In another aspect, step 306 may include positioning one or more buffer elements around and/or extending from two sides of the simulated object (FIG. 6), or positioning one or more buffer elements around and/or extending from multiple sides of the simulated object, or from all sides of the simulated object (FIG. 7). In yet another aspect, step 306 may include positioning one or more buffer elements of different shapes and/or sizes around and/or extending from one or more sides of the object (FIG. 8). Moreover, in another aspect, step 306 may include positioning one or more buffer elements around or extending from one or more internal faces or sides of the object, for example, when the object includes one or more internal openings (FIG. 9).

Method 300 further comprises a step 308, which includes determining whether there is an acceptable number, size, position, etc. of the one or more buffer elements. For example, step 308 may prompt a user to review the number, size, and/or position of the one or more buffer elements. For example, the simulation may generate one unitary buffer element extending parallel to a leading edge of the object (FIG. 4), and the user may wish to instead generate a plurality of buffer elements extending from the leading edge of the object (FIG. 5) in order to conserve build material and binder material. Alternatively or additionally, the simulation may estimate usage of build material and binder material to form the object and the one or more buffer elements. The user may adjust, e.g., the number, size, and/or position of the one or more buffer elements, and the simulation may estimate the usage of build material and binder material based on the adjusted characteristics. For example, a first configuration of buffer elements may yield a more even distribution of build material with increased usage of build material and binder material, but a second configuration of buffer elements may yield a less even distribution of build material with a decreased usage of build material and binder material. The user may add or adjust the buffer element configurations as many times as desired, and system 100 may correspondingly estimate the build material distribution, a sintering time, various structural characteristics, and/or other characteristics or combinations thereof of the printed object. The user may weigh the benefits and drawbacks of the various configurations, and may instruct (e.g., through user interface 112 or a remote computer, smartphone, tablet, laptop, etc.) whether to proceed to the next step of method 300 or to adjust the buffer element configurations in the printing instructions.

In another aspect, step 308 may include the user manually selecting the number and position of one or more buffer elements. In some embodiments, step 308 may include system 100 providing one or more visual and/or textual guides to the user, for example, recommendations or indications of portions of the object which do not require even distribution of build material, portions of the object which do require even distribution of build material, etc. The user may then manually select the number, size, and/or position of buffer elements based on the visual and/or textual guides. In another aspect, step 308 may include the user selecting, either during the performance of method 300 or before the performance of method 300, one or more user preferences, settings, etc., for the automatic generation of one or more buffer elements based on, for example, a selected buffer element location (one side, two sides, all sides, etc.) buffer element size, buffer element quantity, spacing from the printed object, etc.

Next, method 300 may optionally include a step 310 to cause the object to be printed based on the printing instructions, as discussed above with respect to step 308 above. Step 310 may immediately cause the object to be printed once step 308 is completed or may cause the object to be printed at a later time. Step 310 may include forming one or more support structures, one or more interface layers (e.g., formed of a ceramic that does not appreciably sinter at the build material sintering temperatures) between the printed object and the one or more support structures, one or more base or raft structures (e.g., a structure beneath the supports and printed part), which may help maintain a uniform size and shape of the printed object during the formation process, etc. Alternatively or additionally, ceramic may be printed between the part and the buffer elements that contact the part to form an interface layer, for example, in order to assist in separating or breaking the buffer elements from the part.

Method 300 may also include an optional step 312 to treat the printed object. Step 312 may include a debinding portion and/or a sintering portion. For example, step 312 may include one or two phases of heating the printed object to remove additional binder material and to densify and/or harden the printed object, as discussed above with respect to step 210. Step 312 may also include treating only the printed object. For example, the printed object 450 may be separated from build plate 442 and treated at de-powdering subsystem 104 or sintering furnace subsystem 106. Alternatively or additionally, when the one or more buffer elements contact the printed object (e.g., buffer elements 556, 566), the one or more buffer elements may be separated (e.g., broken off) from the printed object either before step 312, during step 312, or after step 312. In this aspect, the one or more buffer elements may optionally be separated from the printed object before sintering the printed object, or after sintering the printed object.

FIG. 4 illustrates a top view of an exemplary user-defined geometry of an object 450 that may be input by a user into system 100 and printed on a print bed 430 by a printer (e.g., binder jet fabrication subsystem 102). The print bed 430 includes a print head 440 and a build plate 442. Print head 440 may be movable in direction A to deposit build material and/or binder material. Print head 440 may include a spreader to deliver and/or spread layers of the build material to build plate 442 and one or more nozzles to deliver the binder material onto the layers of build material. Build plate 442 may be movable downward (i.e., into the page of FIG. 4) during a printing process as layers of the build material and the binder material are delivered. The user-defined geometry of object 450 is based on the finished part that the user wants to obtain when removing the object 450 out of sintering furnace subsystem 106 after treating (e.g., sintering) the object 450.

As shown in FIG. 4, print head 440 may also deliver the binder material onto layers of build material on build plate 442 to form one or more buffer elements 452. Buffer element 452 may be formed “in front of” object 450. Buffer element 452 may be formed at a position adjacent to object 450, for example, spaced away from a leading edge 454 of object 450. Leading edge 454 is the edge of object 450 formed first as print head 440 moves in printing direction A. Buffer element 452 may be formed during the printing process such that the printed buffer element 452 is a thin, solid sheet of material. Buffer element 452 may be shaped and positioned to conform to leading edge 454. For example, buffer element 452 may be formed a constant distance away (e.g., approximately 5 mm or less, approximately 0.3 mm, approximately 100 microns, or approximately 3-5 times a mean particle size of the build material and/or the binder material) from leading edge 454 such that buffer element 452 is spaced away from and matches the shape of leading edge 454. Buffer element 452 may be spaced away from object 450, and may be discarded after printing.

As mentioned above, printing processes often result in a region of a printed object with a higher density of build material compared to the rest of the printed object. This higher density region may be formed at a leading edge of the printed object. In one aspect, forming buffer element 452 at a position ahead of leading edge 454 of object 450 may allow for the region with a higher density of build material to be formed within buffer element 452, instead of within object 450. In this aspect, object 450 may include a more consistent or homogeneous density of printed material, and may result in a lower likelihood of object 450 deforming during one or more processing steps (e.g., sintering). As mentioned, variations in density may cause portions of the part to warp during sintering as portions of the part may shrink at different rates or by different amounts. Buffer element 452 is sacrificial and may be discarded after printing, so any variations in printer material density and/or deformation of buffer element 452 may be immaterial to the finalized formed object or part.

As shown in FIGS. 5-9 and as discussed above, the printing steps may form one or more buffer elements of various shapes, sizes, and positions relative to the printed object.

FIG. 5 illustrates that the one or more buffer elements may be formed of smaller, discrete portions or features along the leading edge of the printed object. These individual buffer elements may be smaller and positioned closely together. For example, the individual buffer elements may be spaced apart by approximately 50 microns, 100 microns, 200 microns, etc. Alternatively, the individual buffer elements may be spaced apart by several millimeters, for example, approximately 1 mm, 3 mm, 5 mm, or 10 mm. The individual buffer elements may contact portions of the leading edge of the printed object, and the contact region between the individual buffer elements and the leading edge of the printed object may be small relative to an overall width or size of the buffer elements. For example, the contact region may be smaller in order to assist in the separation (e.g., breaking off) of the one or more buffer elements from the printed object. The buffer elements may be removed after printing and/or after one or more treatments have been performed, e.g., after one or more of de-powdering, sintering, etc.

For example, FIG. 5 illustrates two printed parts with two different buffer element geometries that may be formed by print head 540 on a build plate 542 of a print bed 530. Objects 550 and 560, along with buffer elements 552 and 562 may be formed during the same printing process, or may be individually formed during separate printing processes.

Object 550 may be printed with buffer element 552. Buffer element 552 may include a plurality of portions or features 556, for example, rectangular pillars or walls, extending away from leading edge 554 of object 550. Features 556 may extend along an entirety of leading edge 554, or, in some embodiments, may extend along less than an entirety of leading edge 554. Features 556 may be spaced away from other features 556 by gaps 558. Features 556 and gaps 558 may be regularly or irregularly sized or spaced. For example, features 556 may be evenly spaced along leading edge 554, or features 556 may be more densely spaced along a portion of leading edge 554 than another portion of leading edge 554. Features 556 may be disconnected or otherwise removed from object 550 before a treatment step (e.g., sintering).

Object 560 may be printed with buffer element 562. Buffer element 562 may include a plurality of features 566, for example, triangular or pyramidal portions, extending away from leading edge 564 of object 560. Features 566 may extend along an entirety of leading edge 564 or less than an entirety of leading edge 564, and may contact leading edge 564 at a point or a smaller surface area than a leading edge of features 566. Features 566 may be spaced away from other features 566 by gaps 568. Features 566 and gaps 568 may be regularly or irregularly sized or spaced. For example, features 566 may be evenly spaced along leading edge 564, or features 566 may be more densely spaced along a portion of leading edge 564 than another portion of leading edge 564. Features 566 may be disconnected or otherwise removed from object 560 before one or more treatment steps (e.g., sintering) or after one or more treatments steps.

FIG. 6 illustrates an object 650 with buffer elements 652A and 652B positioned on two sides of object 650. Although not shown, object 650 and buffer elements 652A and 652B may be formed by a print head on a build plate of a print bed, as discussed above with respect to FIGS. 4 and 5. In particular, the print head may move in direction A and also in direction B in order to deliver build material and/or binder material in a bidirectional printing process. In this aspect, object 650 includes two leading edges 654A and 654B. Accordingly, buffer elements 652A and 652B may include a plurality of features 656A and 656B, for example, triangular or pyramidal portions, extending away from leading edges 654A and 654B of object 650.

Features 656A and 656B may extend along an entirety of respective leading edges 654A and 656B. Features 656A and 656B may be spaced away from each other along leading edges 654A and 654B (like features 566 in FIG. 5), or features 656A and 656B may be coupled together. For example, as shown in FIG. 6, leading edges of features 654A and 656B may touch or abut a leading edge of an adjacent feature. Features 656A and 656B may be regularly or irregularly sized. For example, features 656A and 656B may be evenly spaced along leading edges 654A and 654B, or features 656A and 656B may be more densely spaced along a portion of leading edges 654A and 654B than another portion of leading edges 654A and 654B. Features 656A and 656B may be disconnected or otherwise removed from object 650 before a treatment step (e.g., sintering).

FIG. 7 illustrates an object 750 with a buffer element 752 positioned surrounding object 750. Although not shown, object 750 and buffer element 752 may be formed by a print head on a build plate of a print bed, as discussed above with respect to FIGS. 4 and 5. In particular, the print head may move in any direction (e.g., a randomized direction) relative to object 750 in order to deliver build material and/or binder material in a printing process. In this aspect, object 750 includes edges 754, any of which may be leading edges, depending on the path of the print head when forming a given layer. Accordingly, buffer element 752 may include a plurality of features 756, for example, triangular or pyramidal portions, extending away from edges 754 of object 750.

Features 756 may extend along an entirety of edges 754. Features 756 may be spaced away from each other along edges 754 (like features 566 in FIG. 5), or features 756 may be coupled together. For example, as shown in FIG. 7, leading edges of features 756 may touch or abut a leading edge of an adjacent feature 756. Features 756 may be regularly or irregularly sized or spaced. For example, features 756 may be evenly spaced along edges 754, or features 756 may be more densely spaced along a portion of edges 754 than another portion of edges 754. Additionally, buffer element 752 may include corner features 756A positioned on corners of object 750, which may help surround object 750 and adjoin neighboring features 756 on different edges 754. Features 756 and 756A may be disconnected or otherwise removed from object 750 before a treatment step (e.g., sintering). Although forming buffer element 752 surrounding object 750 may require additional build material and binder material, forming buffer element 752 may help protect object 750 from an uneven material density when a printing direction is randomized, unknown, changing, etc. and/or when the build plate is rotated during a printing process.

FIG. 8 illustrates an object 850 with a varied buffer element structure 852. The buffer structure 852 may be positioned at least on a leading edge 854 of object 850. Although not shown, object 850 and buffer element structure 852 may be formed by a print head on a build plate of a print bed, as discussed above with respect to FIGS. 4 and 5.

Buffer element structure 852 may include a plurality of features 856, which may include different shapes and/or sizes. For example, buffer element structure 852 may include a solid buffer feature 856A, which may be positioned adjacent to and/or around a corner of object 850. Buffer element structure 852 may also include one or more rectangular buffer features 856B. The one or more rectangular buffer features 856B may be spaced apart from each other by a constant or a varied distance and may be similar or different sizes. Buffer element structure 852 may include one or more triangular buffer features 856C, which may point toward leading edge 854 or may point away from leading edge 854. Buffer element structure 852 may include one or more bar-shaped buffer features 856D. The one or more bar-shaped buffer features 856D may be similar size and shapes as rectangular buffer features 856B, or may be different sizes and shapes. Buffer element structure 852 may also include one or more stacked buffer features 856E. Stacked buffer features 856E may be successively spaced away from leading edge 854 such that a group of stacked buffer features 856E extends away from leading edge 854 in a direction opposite to a printing direction. Each of buffer features 856A-856E may contact object 850, or may be spaced apart from leading edge 854 object 850.

FIG. 9 illustrates a top view of an object 950 with an internal buffer element structure. The internal buffer element structure may include one or more internal buffer elements 962, which may be positioned at least adjacent (e.g., touching or spaced apart from) an internal leading edge 964 of object 950. Object 950 and the one or more internal buffer element 962 may be formed by a print head 940 moving in direction A on a build plate 942 of a print bed 930, as discussed above with respect to FIGS. 4 and 5. Additionally, although not shown, one or more buffer elements may be formed upstream of an external leading edge 954 of object 950, as discussed above.

As shown in FIG. 9, object 950 may include one or more internal openings or cavities 966, which form internal leading edges 964. Internal buffer elements 962 may be formed “in front of” internal leading edges 964 relative to a print direction. Internal buffer elements 962 may be formed at positions adjacent to internal leading edges 964 of object 950. Internal leading edges 964 are the edges of object 950 formed first as print head 940 moves in printing direction A after traversing internal openings 966. Although internal buffer elements 962 are shown as solid buffer elements, internal buffer elements 962 may be formed by a plurality of features, which may include different shapes and/or sizes. Additionally, internal buffer elements 962 may be shaped and positioned to conform to internal leading edges 964.

The size, shape, position, etc., of buffer elements and features 456, 556, 566, 656, 756, 856A-856E, 962 may be varied according to a plurality of considerations. For example, system 100 and methods 200 and 300 may consider reducing or minimizing the warping in the printed object during a treatment step, reducing or minimizing the use of build material and/or binder material to form the printed object and the buffer elements, limitations in the size of the build plate and/or capabilities of the print head, ease of handling of the printed object and/or any connected or adjacent buffer elements during a depowdering process, and any other considerations that may affect the quality of the formed object. Further, system 100 and methods 200 and 300 may consider various aspects of the part, for example, the shape of the printed object, an intended use of the printed object, or more critical portions of the printed object that require a more uniform powder distribution.

Additionally, the system 100 and methods 200 and 300 discussed above may be used to automatically form the one or more buffer elements. The one or more buffer elements may be conformal to the shape of the object, as shown in FIG. 4, or spaced away from the object, as in FIG. 8. Alternatively, the one or more buffer elements may be connected to the printed object, as in FIGS. 5-7. In this aspect, the portion of the one or more buffer elements in contact with the printed object may be small compared to the overall size of the buffer element and/or the object, which may help to disconnect (e.g., break off) the one or more buffer elements from the object. Moreover, as mentioned above, ceramic may be printed between the printed object and the buffer elements to form an interface layer and to assist in the disconnection. The disconnection may be performed at any time after the printing of the object (e.g., after steps 208 or 310). In either aspect, the one or more buffer elements and the build material and binder material may be sacrificial and may be discarded after the printing process. Alternatively, methods 200 and/or 300 may include a thermal debinding step for the one or more buffer elements in which the binder material in the one or more buffer elements is collected to be disposed of, recycled, reused, etc. Further, the build material, e.g., metal powder, from which the binder material has been removed may be disposed of, recycled, reused, etc.

Forming the one or more buffer elements may help to promote a more homogeneous distribution of build material and/or binder material forming the printed object. As a result of the homogeneous distribution, the printed object may be less likely to warp or otherwise deform during a treatment process (e.g., heating or sintering). As discussed above, if the density of the powder within a layer changes across the layer, sintering the printed part may cause the part to shrink unevenly, warp, and/or to otherwise change shape during the sintering, which may negatively affect the integrity, strength, shape, or other aspects of the printed part. The final formed part may produce a more dimensionally accurate part based on the printing instructions. As a result, printing objects with the one or more buffer elements may yield a higher quality and/or higher quantity of printed object. The printed objects may require less post-processing, and may be less likely to result in waste due to unsuitability of the part. Accordingly, printing one or more additional components adjacent to an object being printed may actually help to conserve total build material and binder material.

Alternatively or additionally, the above systems and methods may include positioning other (e.g., lesser quality) parts adjacent to the printed object. For example, when printing a plurality of objects, a first part that includes a simpler part geometry and/or is of a lower quality may be positioned adjacent to and along a leading edge of a second, higher quality, part such that the first part may help ensure a homogeneous distribution of material in the second part. Accordingly, a lower quality part may act as a buffer element and may be used in addition to other buffer elements or instead of buffer elements. Moreover, alternatively or additionally, external leading edges 454, 554, 564, 654, 754, 854 or internal leading edges 964 may be physically removed or reduced in thickness relative to a thickness of the printed object. For example, a leading edge may be physically removed or reduced by sanding, milling, etc. after printing but before sintering. In this aspect, removing or reducing the leading edge, which may have a higher particle density, may help to reduce the uneven sintering and, thus, may help to reduce uneven shrinking, warping or deformation of the printed object.

Furthermore, buffer elements and features 456, 556, 566, 656, 756, 856A-856E, 962 may be formed as solid shapes or as shapes with a non-solid internal structure. For example, buffer elements and features 456, 556, 566, 656, 756, 856A-856E, 962 may be formed with a solid outer shell and a non-solid internal infill structure. The outer shell may define an exterior of a buffer element or feature. The infill structure may occupy a volume encompassed by the shell, and may define a network of channels, which may or may not be interconnected. Alternatively, buffer elements and features 456, 556, 566, 656, 756, 856A-856E, 962 may be printed as thin, solid elements. In either aspect, buffer elements and features 456, 556, 566, 656, 756, 856A-856E, 962 may be formed in a manner to reduce the required powder material and binder to form the buffer elements or features, while also ensuring that buffer elements and features 456, 556, 566, 656, 756, 856A-856E, 962 help to reduce the inconsistencies in density of the printed object. In some embodiments, the infill structure of the buffer elements or features may match an infill structure of the part adjacent o which it is printed or may be different than an infill structure of the part adjacent o which it is printed.

It is further noted that the powder deposition direction and the binder deposition direction need not be the same direction. For example, powder material may be deposited in direction A in FIG. 6, and binder may be deposited in direction B in FIG. 6. In this aspect, the leading edge of the printed object may be one or both of the upstream edge of the printed object relative to the powder deposition direction and the binder deposition direction. In one aspect, the buffer elements or features may be formed along a leading edge relative to the powder deposition direction. In another aspect, the buffer elements or features may be formed along a leading edge relative to the binder deposition direction. In yet another aspect, the buffer elements or features may be formed along the leading edge relative to the powder deposition direction and along the leading edge relative to the binder deposition direction.

Lastly, any of the instructions and/or method steps discussed herein may be stored and/or performed by software. For example, one or more components of system 100 (e.g., binder jet fabrication subsystem 102, user interface 110, cloud-based application 114, etc.) may include computer-readable software configured to execute method 200 or method 300. The software may also include previously-stored user-preferences, part geometries, buffer element performance data, etc.

Other embodiments of the present invention will be apparent to those skilled in the art from consideration of the specification and practice of the embodiments disclosed herein. While certain features of the present invention are discussed within the context of exemplary systems, devices, and methods, the invention is not so limited and includes alternatives and variations of the examples herein according to the general principles disclosed. It is intended that the specification and examples be considered as exemplary only, with a true scope and spirit of the present invention being indicated by the following claims.

What is claimed is:

1. A method of printing an object using additive manufacturing, the method comprising:
depositing an amount of powder onto a print bed;
spreading the amount of powder into a layer;
depositing, in a first direction, a fluid configured to bind the powder onto at least a portion of the layer in a cross-sectional shape of the object to form the object; and
depositing the fluid configured to bind the powder onto at least a portion of the layer adjacent to a leading edge of the cross-sectional shape of the object in the first direction to form at least one buffer element upstream of the cross-sectional shape of the object in the first direction.

2. The method of claim 1, wherein the at least one buffer element includes a shape that conforms to a shape of the leading edge of the cross-sectional shape of the object.

3. The method of claim 1, further comprising:
depositing a second amount of powder onto the print bed;
spreading the second amount of powder into a second layer;
depositing, in a second direction, the fluid configured to bind the powder onto at least a portion of the second layer in a cross-sectional shape of the object to form the object; and
depositing the fluid configured to bind the powder onto at least a portion of the second layer adjacent to a leading edge of the cross-sectional shape of the object in the second direction to form at least one buffer element upstream of the cross-sectional shape of the object in the second direction.

4. The method of claim 3, wherein the first direction is different than the second direction so that the leading edge of the cross-sectional shape of the object in the first direction is different than the leading edge of the cross-sectional shape of the object in the second direction.

5. The method of claim 4, wherein the second direction is opposite to the first direction.

6. The method of claim 3, further comprising:
depositing a third amount of powder onto the print bed;
spreading the third amount of powder into a third layer;
depositing, in the first direction, the fluid configured to bind the powder onto at least a portion of the third layer in a cross-sectional shape of the object to form the object; and
depositing the fluid configured to bind the powder onto at least a portion of the third layer adjacent to the leading edge of the cross-sectional shape of the object in the first direction to form the at least one buffer element upstream of the cross-sectional shape of the object in the first direction.

7. The method of claim 3, further comprising:
depositing a third amount of powder onto the print bed;
spreading the third amount of powder into a third layer;
depositing, in a third direction, the fluid configured to bind the powder onto at least a portion of the third layer in a cross-sectional shape of the object to form the object; and
depositing the fluid configured to bind the powder onto at least a portion of the third layer adjacent to a leading edge of the cross-sectional shape of the object in the third direction to form at least one buffer element upstream of the cross-sectional shape of the object in the third direction,
wherein the third direction is different than the first direction and the second direction so that the leading edge of the cross-sectional shape of the object in the third direction is different than the leading edges of the cross-sectional shape of the object in the first direction and the second direction.

8. The method of claim 1, wherein depositing the fluid configured to bind the powder to form the at least one buffer element includes forming the at least one buffer element adjacent the leading edge and at least one other edge of the cross-sectional shape of the object.

9. The method of claim 1, wherein the at least one buffer element is sacrificial to the object,
wherein forming the at least one buffer element reduces uneven powder distribution in the cross-sectional shape of the object, and
wherein the method further comprises sintering the printed object without the at least one buffer element.

10. The method of claim 1, wherein forming the at least one buffer element includes forming a plurality of buffer elements adjacent to and in contact with the leading edge,
and wherein the method further comprises:
separating the buffer elements from the object, once printed; and
sintering the printed object.

11. The method of claim 1, wherein the at least one buffer element is spaced away from the object by less than approximately 5 mm.

12. A method of printing an object using additive manufacturing, the method comprising:
depositing layers of powder;
depositing a binder material onto successive layers of the layers of powder to form the object,
wherein depositing a first layer of the successive layers includes:
depositing, in a first direction, the binder material in a two-dimensional shape of the object in a plane to form the object; and
depositing the binder material in the plane proximate to and separated from the two-dimensional shape of the object to form at least one buffer element adjacent a leading edge of the two-dimensional shape of the object in the first direction such that the at least one buffer element is formed upstream of the two-dimensional shape of the object in the first direction.

13. The method of claim 12, wherein a side of the at least one buffer element facing the two-dimensional shape of the object includes a shape that conforms to a shape of the leading edge of the two-dimensional shape of the object.

14. The method of claim 12, wherein depositing a second layer of the successive layers includes:
depositing, in a second direction, the binder material in a two-dimensional shape of the object in a second plane to form the object; and
depositing the binder material in the second plane proximate to and separated from the two-dimensional shape of the object to form at least one buffer element adjacent a leading edge of the two-dimensional shape of the object in the second direction such that the at least one buffer element is formed upstream of the two-dimensional shape of the object in the second direction.

15. The method of claim 14, wherein the first direction is opposite to the second direction so that the leading edge of the cross-sectional shape of the object in the first direction is different than the leading edge of the cross-sectional shape of the object in the second direction.

16. The method of claim 12, wherein the at least one buffer element is spaced away from the cross-sectional shape of the object by less than approximately 5 mm.

17. An apparatus for printing an object using additive manufacturing, the apparatus comprising:
a build plate;
a powder source configured to deposit a powder onto the build plate;
a powder spreader configured to spread the powder across the build plate to form a layer of powder;
a print head configured to deposit a binder material onto the layer of powder; and
a controller configured to receive instructions to form the object out of the powder and the binder material on the build plate, wherein the controller is configured to:
instruct the powder source to deposit an amount of powder onto the build plate;
instruct the powder spreader to spread the amount of powder into the layer; and
instruct the print head to deposit, in a first direction, the binder material onto at least a portion of the layer in a cross-sectional shape of the object to form the object, and to deposit the binder material onto at least a portion of the layer adjacent to a leading edge of the cross-sectional shape of the object in the first direction to form at least one buffer element upstream of the cross-sectional shape of the object in the first direction.

18. The apparatus of claim 17, wherein the controller is further configured to:
instruct the powder source to deposit a second amount of powder;
instruct the powder spreader to spread the second amount of powder into a second layer; and
instruct the print head to deposit, in a second direction, the binder material onto at least a portion of the second layer in a cross-sectional shape of the object to form the object, and to deposit the binder material onto at least a portion of the second layer adjacent to a leading edge of the cross-sectional shape of the object in the second direction to form at least one buffer element upstream of the cross-sectional shape of the object in the second direction.

19. The apparatus of claim 17, wherein the controller is configured to instruct the print head to deposit the binder material onto the layer surrounding the cross-sectional shape of the object to form at least one buffer element surrounding the cross-sectional shape of the object.

20. The apparatus of claim 17, wherein the at least one buffer element includes a side having a shape that is conformal to a shape of the leading edge of the cross-sectional shape of the object and is spaced away from the cross-sectional shape of the object by less than approximately 5 mm.

21. A method of printing an object using additive manufacturing, the method comprising:
depositing, in a first direction, an amount of powder onto a print bed;
spreading the amount of powder into a layer;
depositing, in a second direction, a fluid configured to bind the powder onto at least a portion of the layer in a cross-sectional shape of the object to form the object; and
depositing the fluid configured to bind the powder onto at least a portion of the layer adjacent to a leading edge of the cross-sectional shape of the object in the second direction to form at least one buffer element upstream of the cross-sectional shape of the object in the second direction,
wherein the first direction is different than the second direction.
